(19) United States
(12) Patent Application Publication
(10) Pub. No.: US 2003/0148179 A1
(43) Pub. Date: Aug. 7, 2003

(54) Sealing material for electrochemical element and electrochemical element containing the same

(76) Inventors: Takao Uyama, Osaka (JP); Mitsugu Okahisa, Osaka (JP); Toshihiko Ikehata, Osaka (JP); Susumu Yamanaka, Osaka (JP); Toshihide Okamoto, Kameyama-shi (JP); Shigenori Sato, Suzuka-shi (JP); Yoshinori Tanaka, Sakai-gun (JP); Fukuji Tsubota, Fukui-shi (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(21) Appl. No.: 10/297,274

(22) PCT Filed: Jun. 4, 2001
(86) PCT No.: PCT/JP01/04700

(30) Foreign Application Priority Data
Jun. 5, 2000 (JP) 2000-167961

(51) Int. Cl. H01M 2/08

(52) U.S. Cl. 429/185; 429/174

(57) ABSTRACT

In order to give excellent hermeticity in a broad temperature range to an electrochemical device, a sealant comprising a rubber component and a tackifier is used, the rubber component comprising at least one of butyl rubber and polyisobutylene rubber, the tackifier comprising at least one selected from the group consisting of a terpene resin, an aliphatic petroleum resin and an alicyclic petroleum resin.

### TECHNICAL FIELD

The present invention relates to a sealant for electrochemical devices which utilize an electrochemical reaction, such as batteries, electric double layer capacitors and aluminum electrolytic capacitors. Further, the present invention also relates to an electrochemical device having excellent hermeticity in a broad temperature range.

### BACKGROUND ART

Most of electrochemical devices comprise: a device unit in which a pair of electrodes disposed to face each other via a separator; an electrolyte; and a container accommodating them. In general, the container is composed of a bottomed-end metal case having an opening, and a sealing member for sealing the opening. The metal case is available in various shapes such as a bottomed-end cylindrical shape, a rectangular shape and a button shape. A gasket having electric insulating properties may be provided between the metal case and the sealing member. Sealed by a sealant is the gap between the open-end of the metal case and the sealing member, the gap between the open-end of the metal case and the gasket or the gap between the gasket and the sealing member.

The sealant is used for the purpose of preventing leakage or evaporation of the electrolyte and preventing infiltration of moisture into the electrochemical device. In particular, since the non-aqueous electrolyte and the electrodes tend to be affected by the moisture, prevention of infiltration of the moisture into the device is important.

While a variety of sealants have conventionally been proposed, pitch such as asphalt and coal tar have been most widely used. For example, in Japanese Laid-Open Patent Publication No. Sho 50-10365, pitch is singly used as a sealant. However, since pitch becomes brittle at low temperatures and gets soft at high temperatures, liquid leakage at high temperatures and low temperatures cannot be sufficiently prevented even with the use of the sealant comprising pitch alone.

In order to overcome such a disadvantage, Japanese Examined Patent Publication No. Sho 61-36344 proposes mixing of a mineral oil in pitch, and Japanese Laid-Open Patent Publication No. Sho 63-80471 proposes mixing of silicone rubber in pitch. However, as the use of electrochemical devices has been tightened up in recent years, it is difficult, after all, to sufficiently prevent the liquid leakage of the electrochemical device by the use of the sealant including pitch. For example, in a heat cycle test where an electrochemical device is exposed in cycles to high temperatures of about 60° C. and low temperatures of about −10° C., satisfactory results have not been obtained.

Moreover, with a silicon rubber added to pitch, although development of brittleness of the sealant at low temperatures can be prevented, compatibility between pitch and a silicon rubber is low. Repetition of the heat cycles thus causes a silicon rubber to be separated from pitch, thereby the performance of the sealant deteriorates.

Incidentally, electric appliances using electrochemical devices have been required to achieve higher performance and a smaller size. Thereby, electrochemical devices to be accommodated in the electric appliances are also required to be downsized, without impairing the electric capacities thereof. As the electrochemical device is made smaller, the strength of the sealing part thereof decreases. It hence becomes even more difficult to obtain sufficient hermeticity by the use of a conventional sealant. For example, since a sealant comprising pitch alone has low adhesion properties to a gasket, the hermeticity deteriorate with a decreasing adhesion area accompanied with downsizing of the device.

Furthermore, in order to obtain an electrochemical device having a high capacity, attempts have been made to use a variety of electrolytes; a problem may arise, however, that some of the electrolytes dissolve the conventional sealant.

The following are required of a sealant for an electrochemical device:

First, a sealant needs to be one resistant to dissolving in an electrolyte. Although electrolytes with high polarity have been used in recent years for the purpose of increasing capacities of electrochemical devices, such electrolytes with high polarity are apt to dissolve the sealant. Particularly at a high temperature, the sealant tends to dissolve in the electrolyte, causing a drastic loss in hermeticity of the sealing part.

Secondly, the moisture permeability of a sealant is required to be small. Although latex of rubber such as styrene-butadiene rubber and butadiene rubber has been proposed as a sealant resistant to heat cycles, such rubbers tend to be passed by moisture because of the relatively high polarity. Under a highly-humidified condition, therefore, the moisture passes through the sealant to infiltrate into a device. There is another problem with a rubber latex with high polarity that it is apt to dissolve in the electrolyte with high polarity.

Thirdly, a sealant needs to have excellent adhesion properties to a metal case, a sealing member and a gasket. This is because existence of gaps between the sealant and the metal case, between the sealant and the sealing member and between the sealant and the gasket cause leakage of the electrolyte therefrom and infiltration of moisture therethrough into the device.

Fourthly, a sealant needs to be stable against temperature changes. Equipments using electrochemical devices, portable equipments in particular, have a broad range of operating temperature. Sustention of favorable performance of a sealant both at high temperatures and low temperatures is therefore necessitated.

Fifthly, a sealant needs to be one easy to be provided with a uniform thickness to the sealing part. Since hermeticity differs depending on the thickness of the sealant, provision of a sealant with a non-uniform thickness to a sealing part causes the hermeticity of the sealing part to be also non-uniform.

### DISCLOSURE OF INVENTION

It is an object of the present invention to provide a sealant satisfying the aforesaid requirements.

Namely, the present invention relates to a sealant for an electrochemical device comprising a rubber component and a tackifier, the rubber component comprising at least one of butyl rubber and polyisobutylene rubber, the tackifier comprising at least one selected from the group consisting of a terpene resin, an aliphatic petroleum resin and an alicyclic petroleum resin.

The rubber component is resistant to swelling or dissolving in an electrolyte, has small gas permeability and moisture permeability and has excellent adhesion properties to a metal case, a sealing member and a gasket. By adding at least one sort of tackifier, selected from the group consisting of a terpene resin, an aliphatic petroleum resin and an alicyclic petroleum resin, to the rubber component, the adhesion properties of the sealant to the meal case, the sealing member and the gasket as well as the stability thereof against temperature changes can be enhanced. Because the molecular weight of the component of a sealant in accordance with the present invention is larger than that of pitch, the sealant of the present invention will neither become fluid at high temperatures nor become brittle at low temperatures. Accordingly, the sealant of the present invention can adhere to each of the parts in a broad temperature range and can sustain favorable hermeticity of the electrochemical device. Further, a sealant of the present invention is readily applied, with a uniform thickness, to the sealing part.

It is preferable that a sealant for the electrochemical device of the present invention contains 3 to 150 parts by weight of the tackifier per 100 parts by weight of the rubber component.

A sealant for the electrochemical device of the present invention can further comprises a vulcanizing agent of thiazole type, thiuram type, quinone type or dithiocarbamate type. With the vulcanizing agent in use, the rubber component can be chemically cross-linked. The cross-linking of the rubber component leads to further improvement of the stability of the sealant at high temperatures.

The present invention also relates to an electrochemical device comprising: a device unit comprising a positive electrode and a negative electrode disposed to face each other via a separator; an electrolyte in contact with the device unit; a metal case accommodating the device unit and the electrolyte; a sealing member sealing the opening of the metal case; and a sealant of the present invention intervening between the open-end of the metal case and the sealing member.

The present invention also relates to an electrochemical device comprising: a device unit comprising a positive electrode and a negative electrode disposed to face each other via a separator; an electrolyte in contact with the device unit; a metal case accommodating the device unit and the electrolyte; a sealing member sealing the opening of the metal case; a gasket intervening between the metal case and the sealing member; a sealant of the present invention intervening at least between the gasket and the open-end of the metal case or between the gasket and the sealing member.

While adherability of the conventional sealant to polypropylene or polyphenylene sulfide has been poor, a sealant, comprising as a tackifier at least one selected from the group consisting of a terpene resin, an aliphatic petroleum resin and an alicyclic petroleum resin, has excellent adhesion properties to polypropylene and polyphenylene sulfide. Therefore, a sealant of the present invention can also be used for an electrochemical device having a sealing member or a gasket that comprises polypropylene and polyphenylene sulfide. From such a perspective, the present invention further relates to the aforesaid electrochemical device, wherein the metal case has one electrode terminal and the sealing member has the other electrode terminal, and the gasket comprises a polyphenylene sulfide resin.

It is preferable that, in an electrochemical device of the present invention, the electrolyte comprises at least one selected from the group consisting of ether, ester, alcohol and ketone. As the ether, for example, 1,2-dimethoxyethane, diethoxyethane or tetrahydrofuran can be used. As the ester, for example, propylene carbonate, ethylene carbonate, butylene carbonate or r-butyrolactone can be used.

### BRIEF DESCRIPTION OF DRAWINGS

FIG. 1 is a vertical sectional view of a cylindrical non-aqueous electrolyte battery in accordance with the present invention.

FIG. 2 is a fragmentary vertical sectional view of an electric double layer capacitor in accordance with the present invention.

FIG. 3 is a vertical sectional view of a flat type non-aqueous electrolyte battery in accordance with the present invention.

### BEST MODE FOR CARRYING OUT THE INVENTION

A sealant for an electrochemical device of the present invention comprises: a rubber component comprising butyl rubber, polyisobutylene rubber or the mixture thereof; and a tackifier comprising at least one selected from the group consisting of a terpene resin, an aliphatic petroleum resin and an alicyclic petroleum resin. By mixing the rubber component with the tackifier, the sealant is given adhesion properties that cannot be obtained by the rubber component alone. Further, softness of the rubber component improves while the coefficient of elasticity thereof decreases.

Accordingly, even in a case where a metal case, a sealing member or a gasket has subtle asperities on the surface thereof, when the sealant is applied onto the surface for sealing a device, the sealant readily extends due to pressure at the time of the sealing and fills the concave portion, whereby the sealing part is sealed.

Next, an embodiment of an electrochemical device of the present invention will be set forth:

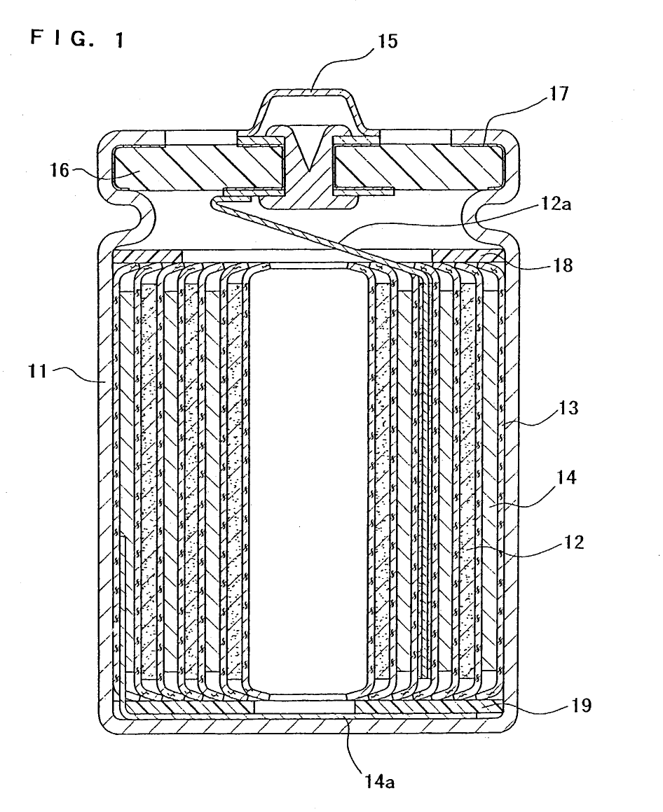

FIG. 1 is a vertical sectional view of a cylindrical non-aqueous electrolyte battery. In FIG. 1, a device unit formed by disposing a positive electrode 12 and a negative electrode 14 to face each other via a separator 13 and by winding the whole, and a non-aqueous electrolyte are accommodated in a metal case 11. However, the non-aqueous electrolyte is not illustrated in FIG. 1. To the upper and lower part of the device unit provided are an upper part insulating ring 18 and a lower part insulating ring 19 for ensuring prevention of short-circuit of the electrode. A positive electrode lead 12a connected to the positive electrode 12 is electrically connected to a sealing member 16 with a positive electrode terminal 15 disposed thereon. Meanwhile, a negative electrode lead 14a connected to the negative electrode 14 is electrically connected to the metal case 11 also serving as a negative electrode terminal. In this electrochemical device, a sealant 17 of the present invention is provided between the open-end of the metal case 11 and the periphery of the sealing member 16.

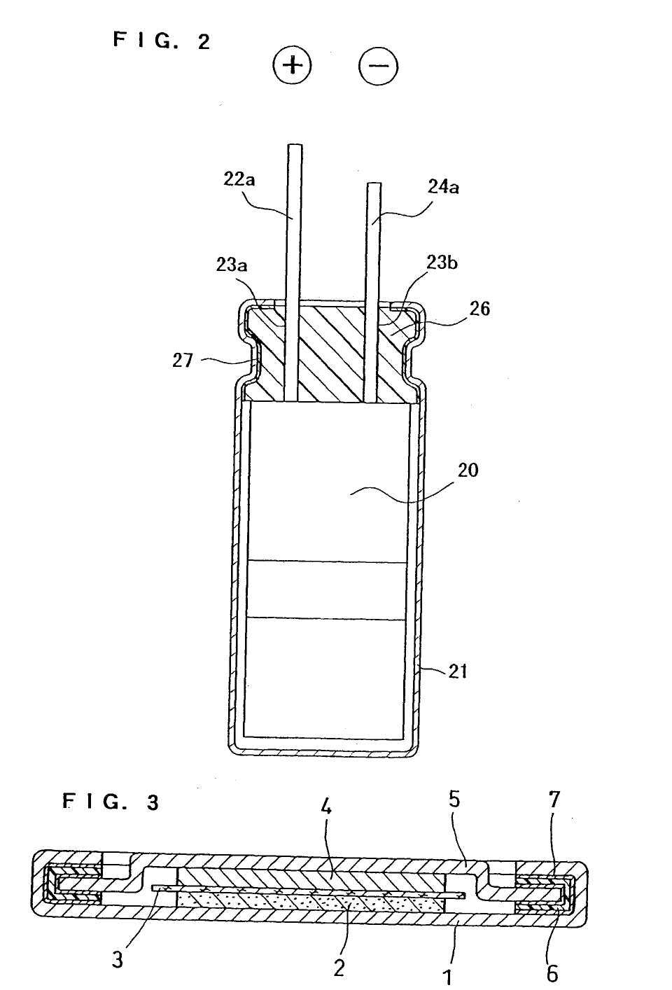

FIG. 2 is a fragmentary sectional view of an electric double layer capacitor. In FIG. 2, a device unit 20 formed by disposing a positive electrode and a negative electrode to face each other via a separator and by winding the whole, and a non-aqueous electrolyte are accommodated in a metal case 21. In FIG. 2, however, neither the non-aqueous electrolyte is illustrated nor the cross section of the device unit 20 is shown. The opening of the metal case 21 is sealed by a sealing member 26 having through holes 23a and 23b. A positive electrode lead 22a and a negative electrode lead 24a are connected, respectively, to the positive electrode and the negative electrode constituting the device unit 20, which are guided to the outside through the through holes 23a and 23b. The open-end of the metal case 21 is crimped onto the upper circumferential part of a sealing member 26 by means of a squeezing process. In this electrochemical device, a sealant 27 of the present invention is provided between the open-end of the metal case 21 and the side part as well as the upper circumferential part of the sealing member 26. It should be noted that the sealant can also be provided between the positive electrode lead 22a and the internal face of the through hole 23a, and between the negative electrode lead 24a and the internal face of the through hole 23b.

The electrochemical device of the present invention such as thus described can be obtained by applying a sealant with a thickness of 5 to 100 μm onto a predetermined section of a metal case, a sealing member or a gasket and by sealing the device.

With adhesion properties and flexibility given to a sealant of the present invention, even when the metal case, the sealing member or the gasket expands or shrinks as accompanying a temperature change, the sealant can extend following the change. Liquid leakage can therefore be prevented with reliability without impairing the hermeticity of the electrochemical device due to the temperature change.

Butyl rubber is a generic term of a copolymer of isobutylene and isoprene, and generally referred to as IIR. The degree of unsaturation of a butyl rubber is 0.6 to 3.0 mol %. Further, the Mooney viscosity of a butyl rubber measured at 100° C. is preferably from 40 to 90. The Mooney viscosity of a butyl rubber can be measured according to a test method for unvulcanized rubber (JIS K6300).

Polyisobutylene rubber is a rubber having a high degree of saturation, obtained by polymerizing isobutylene. The polyisobutylene rubber is in semisolid form at the viscosity-average molecular weight of 100,000 or lower, and it is a solid having rubber-like elasticity at the viscosity-average molecular weight of 800,000 to 2,000,000.

In the case of using a mixture of butyl rubber and solid isobutylene rubber having rubber-like elasticity, the content of the solid isobutylene rubber in the mixture is arbitrary. On the other hand, in the case of using a mixture of butyl rubber and polyisobutylene rubber in semisolid form, the content of the butyl rubber in the mixture is preferably not less than 20 wt %.

The preferable tackifiers to be used for a sealant of the present invention are a terpene resin, an aliphatic petroleum resin and an alicyclic petroleum resin. These can be used singly or in combination of two or more of them. These resins have favorable compatibilities to butyl rubber and polyisobutylene rubber, and excellent resistance to the electrolyte.

As a terpene resin used can be “YS resin P” and “A series” manufactured by Yasuhara Chemical Co.,Ltd, “Pico light A” and “C series” manufactured by Hercules Incorporated, and the like.

As a aliphatic petroleum resin used can be “Quinton A and B series” manufactured by Nippon Zeon Co.,Ltd., “Escorez 1000 series” manufactured by Exxon Chemical Company, and the like.

As a alicyclic petroleum resin used can be “Alcon P and M series” produce by ARAKAWA CHEMICAL INDUSTRIES LTD., and the like.

While such tackifiers as a rosin resin, a coumarone resin, a styrene resin and an alkylphenol resin are known, the use of these resins would result in a sealant having insufficient performance because of the low compatibility thereof with the rubber component. A sealant of the present invention preferably comprises 3 to 150 parts by weight, more preferably 3 to 120 parts by weight of the tackifier, and 100 parts by weight of the rubber component. When the amount of the tackifier per 100 parts by weight of the rubber component is less than 3 parts by weight, the adhesion properties of the sealant become insufficient, and hence sufficient sealing properties cannot be obtained. Further, when the amount of the tackifier per 100 parts by weight of the rubber component exceeds 150 parts by weight, the sealant becomes brittle at low temperatures, causing the sealing properties to deteriorate.

When the sealant is added with a vulcanizing agent of thiazole type, thiuram type, quinone type or dithiocarbamate type, the rubber component can be cross-linked. Thereby, the stability of the sealant at high temperatures further improves. The aforesaid vulcanizing agents may be used singly or in combination of two or more of them.

As a thiazole type vulcanizing agent used can be 2-mercaptobenzothiazole, dibenzothiazolyl disulfide and the like.

As a thiuram type vulcanizing agent used can be tetramethylthiuram disulfide, tetramethylthiuram monosulfide and the like.

As a quinone type vulcanizing agent used can be quinone dioxime, dibenzoyl quinone dioxime and the like.

As a dithiocarbamate type vulcanizing agent used can be zinc diethyldithiocarbamate, zinc dibutyldithiocarbamate and the like.

The amount of a vulcanizing agent to be added to a sealant is preferably from 0.2 to 7 parts by weight per 100 parts by weight of a rubber component.

Next, the present invention will be described concretely based on examples of a flat type non-aqueous electrolyte battery. However, the present invention is not limited to the following examples.

### EXAMPLE 1

FIG. 3 is a vertical sectional view of a flat type manganese dioxide/lithium battery with a thickness of 0.5 mm and a diameter of 20 mm, fabricated in the present example.

FIG. 3 shows a state where the gap between a gasket 6 and a metal case 1 and the gap between the gasket 6 and a sealing plate 5 are sealed by a sealant 7. In FIG. 3, the metal case 1 is made of a stainless steel plate with a thickness of 0.1 mm and also serves as a positive electrode terminal. A positive electrode 2, obtained by pressure-molding a mixed powder of manganese dioxide, graphite and a binder into a pellet with a thickness of 0.18 mm, is connected to the internal face of the metal case 1. The upper face of the positive electrode 2 is covered with a separator 3 with a thickness of 0.03 mm, made of a porous polypropylene sheet. A negative electrode 4 comprising metal lithium with a thickness of 0.06 mm is disposed so as to face the positive electrode 2 via the separator 3. The negative electrode 4 is attached onto the internal face of a sealing plate 5 in substantially patelliform with a thickness of 0.1 mm, made of a stainless steel plate, and also serves as a negative electrode terminal. On a periphery of the sealing plate 5 disposed is a gasket 6 in film form with a thickness of about 0.1 mm, made of a polyphenylene sulfide, and this gasket 6 serves to insulate the sealing plate 5 and the metal case 1. The open-end of the metal case 1 is crimped onto the periphery of the sealing plate 5 via the gasket 6.

In the present example, the following sealant having dissolved in toluene was applied onto the inner side face and the circumferential part of the inner bottom face of the metal case 1 and the periphery of the sealing plate 5, followed by drying, to assemble the aforesaid battery. As a result, the gap between the gasket 6 and the metal case 1 and the gap between the gasket 6 and the sealing plate 5 were sealed by the sealant, as shown in FIG. 3.

The sealant was prepared by mixing 100 parts by weight of butyl rubber, with a degree of unsaturation of 2 mol % and a Mooney viscosity of 75, with 30 parts by weight of an aliphatic petroleum resin (Quinton A-100 manufactured by Nippon Zeon Co.,Ltd.) having a softening point of 100° C. as a tackifier. The battery obtained using this sealant was referred to as Battery A.

### EXAMPLE 2

Except for the use of a sealant prepared by mixing 100 parts by weight of polyisobutylene rubber having a viscosity-average molecular weight of 900,000 with 30 parts by weight of the same tackifier as used in Example 1, Battery B was fabricated in the same manner as in Example 1.

### COMPARATIVE EXAMPLE 1

Except for the use of a sealant prepared by mixing 100 parts by weight of styrene-butadiene rubber, with a styrene content of 23% and a Mooney viscosity of 50, with 30 parts by weight of the same tackifier as used in Example 1, Battery C was fabricated in the same manner as in Example 1.

### COMPARATIVE EXAMPLE 2

Except for the use of a sealant prepared by mixing 100 parts by weight of styrene-butadiene-styrene block rubber, with a styrene content of 30% and a melt flow rate (MFR) of 6, with 30 parts by weight of the same tackifier as used in Example 1, Battery D was fabricated in the same manner as in Example 1.

### COMPARATIVE EXAMPLE 3

Except for the use of a sealant prepared by mixing 100 parts by weight of ethylene-propylene-diene monomer rubber, with an ethylene content of 63 mol % and a Moony viscosity of 38, with 30 parts by weight of the same tackifier as used in Example 1, Battery E was fabricated in the same manner as in Example 1.

Ten articles each of Batteries A to E were stored in a constant-temperature-constant-moisture bath at 60° C. with a humidity of 90% for 30 days, and then stood still at 20° C. for a day. Thereafter, internal resistances of the batteries were measured. The average values of the obtained measured values are shown in Table 1. It is to be noted that any of the internal resistances of the batteries before the storage in the constant-temperature-constant-moisture bath was from 20 to 25 Ω.

TABLE 1

| Battery | Kind of Rubber | Internal resistance (Ω) |
|---|---|---|
| A | Butyl rubber | 32 |
| B | Polyisobutylene rubber | 35 |
| C | Styrene-butadiene rubber | 78 |
| D | Styrene-butadiene- | 70 |
| | styrene block rubber | |
| E | Ethylene-propylene-diene | 45 |
| | monomer rubber | |

Next, moisture permeability of the rubber components used in Batteries A to E were measured by the method shown in JIS Z0208. A film thickness of a sample was 20 μm and a measurement condition was a temperature of 45° C. and a humidity of 90%.

Furthermore, 1 g of the sample of the rubber component was soaked, for a week, in a non-aqueous electrolyte comprising a mixed liquid of propylene carbonate and dimethoxyethane used in producing the above batteries, to measure a change in weight of the sample.

The obtained moisture permeability and change in weight are shown in Table 2.

TABLE 2

| | Moisture | |
|---|---|---|
| Kind of rubber | permeability | Change in |
| component | (g/m² · 24 hr) | weight (mg) |
| Butyl rubber | 15 | +90 |
| Polyisobutylene rubber | 17 | +110 |
| Styrene-butadiene | 72 | −10 |
| rubber | | |
| Styrene-butadiene- | 60 | −8 |
| styrene block rubber | | |
| Ethylene-propylene- | 35 | −5 |
| diene monomer rubber | | |

The moisture permeability can be an indicator of easiness of infiltration of moisture into the electrochemical device. It indicates that: the lower the moisture permeability, it becomes more difficult for the moisture to infiltrate into the device.

Moreover, the change in weight can be an indicator of resistance characteristics of the sealant to the electrolyte. A value of “+” indicates that: the sealant swells due to the electrolyte, but does not elute in the electrolyte, and therefore the performance of the sealant is sustained. On the other hand, a value of “n−” indicates that: the sealant dissolves in the electrolyte and thus a gap is likely to occur in the sealing part of the electrochemical device.

It is understood from Table 2 that the butyl rubber and the polyisobutylene rubber have low moisture permeability and do not dissolve in the electrolyte. On the other hand, the styrene-butadiene rubber and the styrene-butadiene-styrene block rubber have high moisture permeability and are likely to dissolve in the electrolyte.

Accordingly, even when Batteries A and B are stored in the constant-temperature-constant-moisture bath, the internal resistances thereof are stable, as shown in Table 1. On the other hand, when Batteries C and D are stored in the constant-temperature-constant-moisture bath, the internal resistances thereof increase owing to the infiltration of the moisture or the like.

Moreover, it is considered that, since the ethylene-propylene-diene monomer rubber is apt to dissolve in the electrolyte while having relatively low moisture permeability, a gap occured in the sealing part and the moisture infiltrated the device therethrough to cause an increase in internal resistance.

### EXAMPLE 3

Except that the amount of a tackifier contained in a sealant was changed in the range of 3 to 175 parts by weight per 100 parts by weight of butyl rubber, as shown in Table 3, a battery was fabricated in the same manner as in Example 1. However, as the tackifier used was a terpene resin (Pico light A-115 manufactured by Hercules Incorporated).

Using ten articles each of the obtained batteries, a heat cycle test in which a battery was exposed in cycles to a temperature of −20 to +60 ° C. was conducted, to count the number of butteries where liquid leakage has occurred after 250 cycles. The results are shown in Table 3.

TABLE 3

| Added amount of tackifier | Number of occurrence of liquid |
|---|---|
| (parts by weight) | leakage |
| 0 | 5/10 |
| 3 | 1/10 |
| 5 | 0/10 |
| 10 | 0/10 |
| 30 | 0/10 |
| 50 | 0/10 |
| 100 | 0/10 |
| 125 | 0/10 |
| 150 | 0/10 |
| 175 | 3/10 |

In Table 3, almost no liquid leakage occurs in the batteries added with 3 to 150 parts by weight of the tackifier par 100 parts by weight of the butyl rubber during the heat cycle test. This presumably because, since the addition of the aforesaid amount of the tackifier causes the coefficient of elasticity of the tackifier to decline and the sealant thus becomes softer, it becomes easier for the sealant to get in the whole gaps between the metal case, the sealing plate and the gasket. It is also considered that the metal case, the sealing member and the gasket are tightly bonded by the sealant. On the other hand, it is considered that, since the sealant containing the tackifier in an amount of 175 parts by weight per 100 parts by weight of the butyl rubber becomes hard in the region of low temperatures of 0° C. or lower, the hermeticity of the battery is low at −20° C. From the above, it was confirmed that a sealant containing 5 to 150 parts by weight of a tackifier per 100 parts by weight of butyl rubber has excellent resistance characteristics to the heat cycle. Although the terpene resin was used as the tackifier here, it is thought that a similar result may be obtained when using an aliphatic petroleum resin or an alicyclic petroleum resin.

### EXAMPLE 4

Except for the use of a sealant comprising 100 parts by weight of the butyl rubber, 50 parts by weight of the same tackifier as used in Example 1 and 5 parts by weight of dibenzoyl quinone dioxime of a quinone type vulcanizing agent, a battery was fabricated in the same manner as in Example 1.

Further, using a sealant which comprises 100 parts by weight of the butyl rubber and 50 parts by weight of the same tackifier as used in Example 1 and does not comprise a vulcanizing agent, a battery was fabricated in the same manner as in Example 1.

Using ten articles each of the obtained batteries, a bending test for evaluating an IC card shown in JIS X6303 was conducted. In the bending test, the battery was coated with transparent polyethylene terephthalate (PET) to produce a card with a size of 54×76×0.76 mm. The card was then bent in the longitudinal direction and in the lateral direction 125 times each, in a cycle of 30 times/minute. Bending distortion in the longitudinal direction was 2 cm and bending distortion in the lateral direction was 1 cm. Subsequently, the card was turned upside down and then the same operation as above was conducted to bend the card 500 times in total. Thereafter, occurrence or non-occurrence of liquid leakage of the batteries was investigated. The results are shown in Table 4.

TABLE 4

| Presence or absence | Number of occurrence |
|---|---|
| of vulcanizing agent | of liquid leakage |
| Present | 0/10 |
| Absent | 2/10 |

It is found from Table 4 that addition of the vulcanizing agent to the sealant reduces tendency of the liquid leakage of the battery caused by the bending test. This is presumably because, with the use of the vulcanizing agent, the adhesion properties of the sealant to the metal case and the gasket improved. On the other hand, it is thought that, when the battery using the sealant comprising no vulcanizing agent was bent, the sealant peels off the metal case and the gasket, resulting in creation of gaps in the sealing part of the battery.

Next produced were samples in which a sealant comprising a vulcanizing agent or a sealant comprising no vulcanizing agent was provided between stainless steel plates with a thickness of 0.1 mm. Using the obtained samples, a T type peeling test shown in ASTM D 1876-69 (adhesion handbook) was conducted. As a result, the tensile strength of the sealant comprising no vulcanizing agent was 0.6 kgf/cm, while the tensile strength of the sealant comprising the vulcanizing agent was 1.1 kgf/cm. Namely, the strength of the sealant comprising the vulcanizing agent was about twice as high as the strength of the sealant comprising no vulcanizing agent.

### INDUSTRIAL APPLICABILITY

According to the present invention, it is possible to give excellent hermeticity in a broad temperature range to such electrochemical devices as a battery, an electric double layer capacitor and an aluminum electrolytic capacitor.

1. A sealant for an electrochemical device comprising a rubber component and a tackifier,
said rubber component comprising at least one of butyl rubber and polyisobutylene rubber,
said tackifier comprising a terpene resin.

2. The sealant for an electrochemical device in accordance with claim 1, wherein 3 to 150 parts by weight of said tackifier per 100 parts by weight of said rubber component is contained.

3. The sealant for an electrochemical device in accordance with claim 1, further comprising a vulcanizing agent of thiazole type, thiuram type, quinone type or dithiocarbamate type.

4. An electrochemical device comprising: a device unit comprising a positive electrode and a negative electrode disposed to face each other via a separator; an electrolyte in contact with said device unit; a metal case accommodating said device unit and said electrolyte; a sealing member sealing the opening of said metal case; and a sealant intervening between the open-end of said metal case and said sealing member,
wherein said sealant comprises a rubber component and a tackifier, said rubber component comprising at least one of butyl rubber and polyisobutylene rubber, said tackifier comprising at least one selected from the group consisting of a terpene resin, an aliphatic petroleum resin and an alicyclic petroleum resin.

5. An electrochemical device comprising: a device unit comprising a positive electrode and a negative electrode disposed to face each other via a separator; an electrolyte in contact with said device unit; a metal case accommodating said device unit and said electrolyte; a sealing member sealing the opening of said metal case; a gasket intervening between said metal case and said sealing member; a sealant intervening at least between said gasket and the open-end of said metal case or between said gasket and said sealing member,
wherein said sealant comprises a rubber component and a tackifier, said rubber component comprising at least one of butyl rubber and polyisobutylene rubber, said tackifier comprising at least one selected from the group consisting of a terpene resin, an aliphatic petroleum resin and an alicyclic petroleum resin.

6. The electrochemical device in accordance with claim 5, wherein said metal case has one electrode terminal and said sealing member has the other electrode terminal, and said gasket comprises a polyphenylene sulfide resin.

7. The electrochemical device in accordance with claim 4, wherein said electrolyte comprises at least one selected from the group consisting of ether, ester, alcohol and ketone.

8. The electrochemical device in accordance with claim 5, wherein said electrolyte comprises at least one selected from the group consisting of ether, ester, alcohol and ketone.

9. The sealant for an electrochemical device in accordance with claim 4, wherein 3 to 150 parts by weight of said tackifier per 100 parts by weight of said rubber component is contained.

10. The sealant for an electrochemical device in accordance with claim 4, further comprising a vulcanizing agent of thiazole type, thiuram type, quinone type or dithiocarbamate type.

11. The sealant for an electrochemical device in accordance with claim 5, wherein 3 to 150 parts by weight of said tackifier per 100 parts by weight of said rubber component is contained.

12. The sealant for an electrochemical device in accordance with claim 5, further comprising a vulcanizing agent of thiazole type, thiuram type, quinone type or dithiocarbamate type.
